(19) United States
(12) Patent Application Publication
(10) Pub. No.: US 2019/0236406 A1
(43) Pub. Date: Aug. 1, 2019

(54) DYNAMIC GENERATION OF COLOR SCHEME DATA STRUCTURES FOR DIGITAL IMAGES

(71) Applicant: Color Shopping, LLC, Los Angeles, CA (US)

(72) Inventor: Ben Blatt, Los Angeles, CA (US)

(21) Appl. No.: 15/885,669

(22) Filed: Jan. 31, 2018

(51) Int. Cl. G06K 9/62; G06T 7/90; G06F 17/30

(52) U.S. Cl. CPC G06K 9/6221; G06T 7/90; G06K 9/6215; G06T 7/13; G06F 17/30256; G06T 2207/10024; G06F 17/3025

(57) ABSTRACT

Methods and apparatuses are described for generating a color scheme data structure for a digital image. A computing device retrieves a digital image, the image comprising a plurality of pixels and each pixel comprising a plurality of color values. The computing device generates a first plurality of color clusters based upon the color values, each color cluster comprising a plurality of RGB values. The computing device determines a first count of pixels that are similar to at least one of the color clusters and a second count of pixels that are dissimilar to at least one of the color clusters. The computing device assigns each of the pixels to one or more color bins based upon the associated color values. The computing device defines a color scheme data structure for the image, and tags the image with the defined color scheme data structure and the first plurality of color clusters.

### TECHNICAL FIELD

This application relates generally to methods and apparatuses, including computer program products, for dynamically generating color scheme data structures for digital images.

### BACKGROUND

For many web-based applications, the ability to provide color-specific searching and matching between digital images is an important and desired feature. However, many existing color matching techniques are inaccurate and/or have limited functionality. For example, the color search engine provided by Tineye (https://labs.tineye.com/multicolr/) provides only a static color input selector that is not related to existing colors from digital images, and which has a small set of color options. Due to this restrictive color input functionality, the results provided may be inaccurate or may not reflect the precise color that the user desires.

In addition, in such applications, precision of a predetermined set of color options is not scalable as the RGB or HSV encoding systems expands. Color search engines such as Tineye do not allow search by aspects other than individual colors, such as programmatically searching for palettes defined by different boundaries and color properties.

### SUMMARY

Therefore, what is needed is a method and system for dynamically generating robust color schemes based upon colors found in existing digital images, which categorize the image colors into a complex, multi-faceted data structure for use in accurate color searching and matching in computerized image search applications. The techniques described herein provide the further advantage of enabling input from a user's digital image which allows for a color to be searched in other images without transforming the color into a name—providing for a more precise color selection process, with options only limited by the encoding of the color data.

The invention, in one aspect, features a computerized method of generating a color scheme data structure for a digital image. A computing device retrieves a digital image of an object, the digital image comprising a plurality of pixels and each pixel comprising a plurality of color values. The computing device generates a first plurality of color clusters associated with the object based upon the color values of the plurality of pixels in the digital image, each color cluster in the first plurality of color clusters comprising a plurality of RGB values. The computing device determines a first count of pixels in the digital image that are similar to at least one of the color clusters and a second count of pixels in the digital image that are dissimilar to at least one of the color clusters. The computing device assigns each of the plurality of pixels in the digital image to one or more of a plurality of color bins based upon the color values associated with the pixel. The computing device defines a color scheme data structure for the digital image based upon one or more characteristics of the assignment of pixels to the plurality of color bins. The computing device tags the digital image with the defined color scheme data structure and the first plurality of color clusters.

The invention, in another aspect, features a system for generating a color scheme data structure for a digital image. The system comprises means for retrieving a digital image of a object, the digital image comprising a plurality of pixels and each pixel comprising a plurality of color values. The system comprises means for generating a first plurality of color clusters associated with the object based upon the color values of the plurality of pixels in the digital image, each color cluster in the first plurality of color clusters comprising a plurality of RGB values. The system comprises means for determining a first count of pixels in the digital image that are similar to at least one of the color clusters and a second count of pixels in the digital image that are dissimilar to at least one of the color clusters. The system comprises means for assigning each of the plurality of pixels in the digital image to one or more of a plurality of color bins based upon the color values associated with the pixel. The system comprises means for defining a color scheme data structure for the digital image based upon one or more characteristics of the assignment of pixels to the plurality of color bins. The system comprises means for tagging the digital image with the defined color scheme data structure and the first plurality of color clusters.

Any of the above aspects can include one or more of the following features. In some embodiments, the computing device determines whether a portion of the plurality of pixels in the digital image are edge pixels, and discards the digital image if a number of edge pixels in the digital image is below a predetermined threshold. In some embodiments, generating a plurality of color clusters comprises: mapping each of the plurality of pixels in the digital image to a data point in a three-dimensional RGB space; and clustering the data points in the three-dimensional RGB space into a plurality of color clusters using the corresponding color values of the plurality of pixels in the digital image.

In some embodiments, determining a first count of pixels in the digital image that are similar to at least one of the color clusters comprises determining a percentage of pixels in the digital image whose associated plurality of color values are within a predetermined distance of at least one of the color clusters. In some embodiments, determining a second count of pixels in the digital image that are dissimilar to at least one of the color clusters comprises determining a percentage of pixels in the digital image whose associated plurality of color values are not within a predetermined distance of one of the color clusters.

In some embodiments, the computing device generates a second plurality of color clusters based upon the color values of the plurality of pixels at the top of the digital image and at the bottom of the digital image; compares the RGB values of the second plurality of color clusters to the RGB values of the first plurality of color clusters; and discards color clusters from the first plurality of color clusters whose RGB values are within a predetermined distance from the RGB values of at least one of the second plurality of color clusters and whose RGB values are within a predetermined distance of RGB values associated with a human skin tone. In some embodiments, each of the plurality of pixels in the digital image are assigned to one or more of a plurality of color bins based upon a range of the color values associated with the pixel. In some embodiments, the one or more characteristics of the assignment of pixels to the plurality of color bins comprises a percentage of pixels assigned to at least a portion of the plurality of color bins. In some embodiments, the defined color scheme data structure for the digital image comprises a color tag based upon the percentage of pixels assigned to a particular set of color bins.

In some embodiments, the computing device receives, from a remote computing device, a search request comprising one or more product identifiers and one or more color identifiers; determines RGB values associated with the one or more color identifiers; identifies one or more digital images tagged with one or more color clusters that have RGB values within a predetermined distance of the RGB values associated with the one or more color identifiers; and determines one or more of the identified digital images that are associated with at least one of the one or more product identifiers.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The patent or application file contains at least one drawing executed in color. Copies of this patent or patent application publication with color drawings will be provided by the Office upon request and payment of the necessary fee.

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1A is a block diagram of a system for dynamically generating color scheme data structures for digital images.

FIG. 1B is a block diagram of a system for dynamically generating color scheme data structures for digital images

FIG. 2 is a flow diagram of a method of dynamically generating color scheme data structures for digital images.

FIG. 3 is a screenshot of a color selection screen from an application that provides dynamically-generated color scheme data structures for digital images.

FIG. 4 is a screenshot of a search results from an application that provides dynamically-generated color scheme data structures for digital images.

FIGS. 5A to 5D are groups of screenshots from an application, where different inputs are used to initiate the color search.

FIGS. 6A and 6B are groups of screenshots from an application, where a double color selection is used to initiate the color search.

FIGS. 7A and 7B are groups of screenshots from an application, where a complex color scheme is used to initiate the color search.

FIG. 8 is a group of screenshots from an application, where an accent color selection is used to initiate the color search.

FIG. 9 is a group of screenshots from an application, where a color/pattern selection is used to initiate the color search.

### DETAILED DESCRIPTION

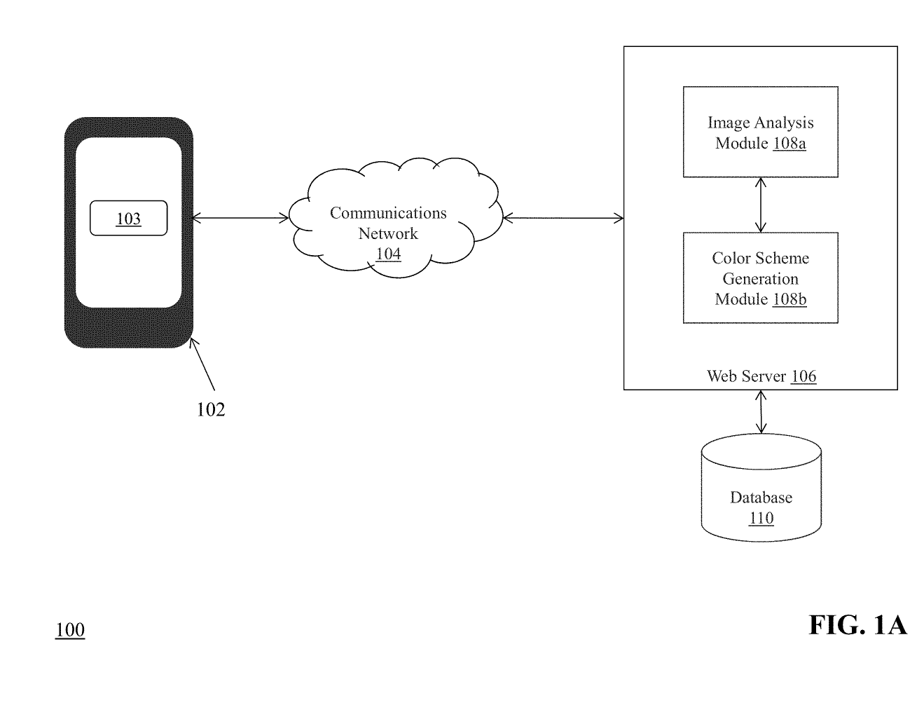

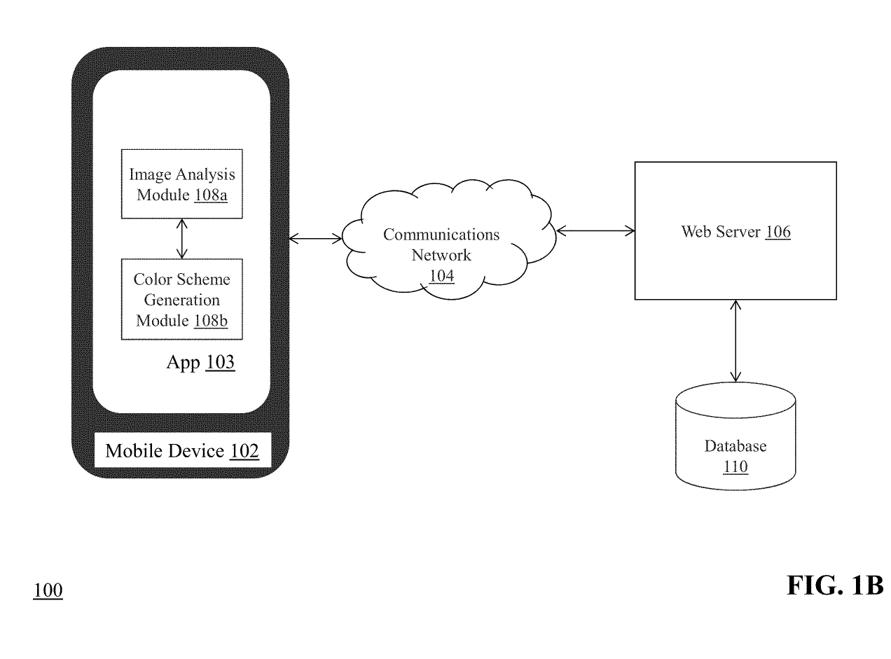

FIG. 1A is a block diagram of a system 100 for dynamically generating color scheme data structures for digital images. The system includes a mobile device 102, an application 103 executing on the mobile device 102, a communications network 104, a web server computing device 106 that includes an image analysis module 108a and a color scheme generation module 108b, and a database 110.

The network device 102 uses software and circuitry (e.g., processor, memory) to execute applications (e.g., application 103) and to communicate with the web server 106 via the communications network 104 for the purpose of transmitting requests for content such as webpages to, e.g., the web server 106 and receiving the requested content from, e.g., the web server 106. In some embodiments, the mobile device 102 is a computing device such as a smartphone or tablet (e.g., Apple iOS®, Windows®, and/or Android™-based device) that uses native application software and/or browser software installed on the device to connect to the communications network 104 via embedded hardware such as a Wi-Fi antenna. Although a mobile computing device is identified herein as an exemplary embodiment, it should be appreciated that the mobile device 102 can be embodied in other forms—such as an Internet of Things (IoT) device, a desktop/laptop computing device, a terminal, and the like—without departing from the scope of invention. The mobile device 102 can also include or otherwise be coupled to components (e.g., camera or other sensor device) that enable the mobile device to electronically capture digital images.

The communications network 104 enables components of the system 100 to communicate with each other using, e.g., a packet-based protocol. The network 104 may be a local network, such as a LAN, or a wide area network, such as the Internet. In some embodiments, the network 104 is comprised of several discrete networks and/or sub-networks (including related routing, load balancing, and traffic metering hardware).

The web server 106 is a combination of hardware (e.g., a processor, memory modules, other circuitry) and software—including specialized software modules 108a, 108b executing on the processor and interacting with the memory modules—to receive data from the mobile device 102 and the database 110, to transmit data to the mobile device 102 and the database 110, and to otherwise communicate with these devices 102, 110 in order to perform functions for dynamically generating color scheme data structures for digital images as described herein. The web server 106 includes an image analysis module 108a and a color scheme generation module 108b (as mentioned above) that execute on and/or interact with the processor of the web server 106.

In some embodiments, the image analysis module 108a and the color scheme generation module 108b are specialized sets of computer software instructions programmed onto one or more dedicated processors in the web server 106 and can include specifically-designated memory locations and/or registers for executing the specialized computer software instructions. Although the image analysis module 108a and the color scheme generation module 108b are shown in FIG. 1A as executing within the same web server 106, in some embodiments the functionality of the image analysis module 108a and the color scheme generation module 108b can be distributed among a plurality of web servers. FIG. 1B depicts an embodiment of the system 100 where the image analysis module 108a and the color scheme generation module 108b are located within the application 103 on the mobile device 102—enabling localized and offline analysis, processing, and generation of the color scheme data structures.

As shown in FIG. 1A, the web server 106 enables the image analysis module 108a and the color scheme generation module 108b to communicate with each other in order to exchange data for the purposes of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of the image analysis module 108a and the color scheme generation module 108b is described in detail throughout this specification.

The image analysis module 108a communicates with the mobile device 102 and the database 110 in order to, e.g., receive digital images captured by the mobile device 102 and/or stored by the database 110 and process the digital images as described herein. The color scheme generation module 108b communicates with the mobile device 102 and/or the database 110 in order to, e.g., generate color scheme data structures for certain digital images, tag the digital images with the color scheme data structures, and transfer or otherwise make the tagged digital images available for the purposes of generating customized search results, as will be described in detail below.

The web server 106 further provides a web-based software application accessible by browser software installed at the mobile device 102. For example, the web server 106 and the mobile device 102 can establish a communication session via HTTP (if communicating, for example, via a web browser) or other protocol (if communicating, for example, via a native app installed on the network device) to exchange requests and responses relating to the generation of color scheme data structures for digital images as described herein. It should be appreciated that a variety of different communication protocols can be used in conjunction with the systems and methods described herein.

The database 110 is a computing device (or in some embodiments, a set of computing devices) coupled to the web server 106, and the database 110 are configured to receive, generate, and store specific segments of data—including the color scheme data structures and tagged images—relating to the process of dynamically generating color scheme data structures for digital images as described herein. In some embodiments, all or a portion of the database 110 is integrated with the web server 106 or in other embodiments, the database 110 is located on a separate computing device or devices. An exemplary database 110 is a MySQL™ database available from Oracle Corp. of Redwood City, Calif.

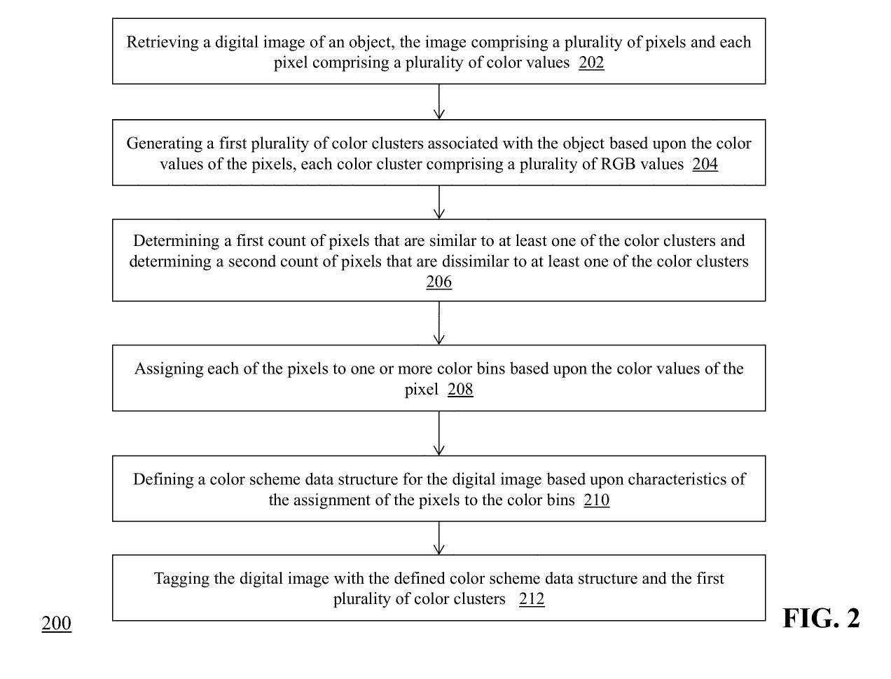

FIG. 2 is a flow diagram of a method 200 of method of dynamically generating color scheme data structures for digital images, using the system 100 of FIG. 1A. It should be appreciated that the same principles apply to the system of FIG. 1B.

The image analysis module 108a of web server 106 retrieves (202) a digital image, e.g., of an object. For example, a user at mobile device 102 can capture a digital image of a physical object in proximity to the mobile device (e.g., using the camera apparatus of the mobile device 102), and the application 103 can transmit the captured digital image to the image analysis module 108a. In another example, the image analysis module 108a of web server 106 can collect a digital image of an object from a local or remote repository (such as database 110). In yet another example, the image analysis module 108a can receive or otherwise acquire a link (e.g., HTTP) to a digital image stored on a remote computing device—such as from an online product catalog or via web crawling).

As can be appreciated, the digital image comprises a plurality of pixels and each pixel in the image is defined by a plurality of color values. Generally, for color images, each pixel is defined by separate values for red, green, and blue (RGB) components—so the value of the pixel is a vector of three numbers (e.g., white=255,255,255). Of course, it should be appreciated that other methods of defining color values for pixels in a digital image (e.g., binary, greyscale, multi-spectral) can be used within the scope of invention. Exemplary file formats for the digital images used by the system include, but are not limited to, JPG, GIF, and PNG.

After the image analysis module 108a has retrieved the digital image, the image analysis module 108a can preprocess the image to ensure that the image is suitable for the color scheme generation process described herein. For example, the image analysis module 108a can check the digital image for cleanliness (such as checking the background of the image to determine if the background is white or near white, as this characteristic can produce better consistency in the results, in some embodiments). The image analysis module 108a can also analyze the image for the presence of a human based on pixel location and color data. This can be used to change the image results, such that only pictures showing fashion items with human models are displayed or only pictures showing fashion items with no model are displayed.

Also, in some embodiments, the image analysis module 108a can analyze the digital image to determine whether the image includes stripes, dots, or other types of patterns. For example, the image analysis module 108a can use the Tensorflow framework to train a machine learning model to detect and recognize the patterns in the digital image. The module 108a can then associate the image with the detected patterns to provide an additional characteristic that can be used in image searching described herein.

The image analysis module 108a then generates (204) a first plurality of color clusters associated with the physical object rendered in the image, the color clusters based upon the color values of the plurality of pixels in the image. Each color cluster comprises a plurality of RGB values. For example, the image analysis module 108a can apply one or more clustering algorithms to the color values defined for the pixels in the image to generate the color clusters. The clustering algorithms analyze the pixels as data points in a 3D RGB space to generate the color clusters.

The image analysis module 108a determines the color clusters using k-clustering algorithms on both RGB and HSV space. Once the color clusters determined through each coordinate space are found, the module 108a compares the computed clusters for uniqueness. The objective is to find the unique clusters in an image, and because of the way color is encoded, relying on one coordinate system can hide results. For instance, Seashell RGB(255,245,238) and Mint Cream RGB(245,255,250) are within a medium distance in the RGB spectrum—but on the HSV spectrum are (24,6,100) and (150,5,100). Similarly, two colors can appear close in HSV space but different in RGB space. By combining the two clustering systems, the module 108a can save the most perceptually unique colors.

Once the color clusters are generated, the color scheme generation module 108b determines (206) a first count of pixels in the digital image that are similar to at least one of the color clusters generated by the image analysis module 108a, and the module 108b determines a second count of pixels in the digital image that are dissimilar to at least one of the color clusters. The color scheme generation module 108b searches the digital image to determine the number of pixels that are similar to each of the color clusters, and the module 108b can represent the number for each color cluster as a percentage. Note that the similarity metric means that the RGB pixel values do not need to be exactly the same as the RGB values of the color clusters. An example: the color scheme generation module 108b can classify a digital image as 15% color RGB(12,200,50)—even if zero pixels have the value of RGB(12,200,50)—because 15% of the pixels in the image have RGB values that are within a predetermined distance of RGB(12,200,50). The color scheme generation module 108b can adjust the similarity metric based on a variety of different considerations.

Similarly, the color scheme generation module 108b determines (206) a second count of pixels in the digital image that are dissimilar to at least one of the color clusters. The color scheme generation module 108b searches the digital image to determine the number of pixels that are dissimilar to each of the color clusters, and the module 108b can represent the number for each color cluster as a percentage. Generally, the threshold value for dissimilarity is different from the threshold value for similarity used above. Therefore, the module 108b generates two percentage values for each color cluster: one value that represents the number of pixels that are similar and a second value that represents the number of pixels that are dissimilar. It should be appreciated that the two percentage values do not typically sum to 100%. As an example, For example, an image may contain a dark green shirt with medium green sleeves. Dark green can be tagged as a main color because most of the shirt is within a set threshold of that color. However, this does not imply that medium green is an accent color. In another example, if the shirt was dark blue with a medium green logo, medium green can come back as an accent color because the blue pixels would count as dissimilar to the medium green logo.

In some embodiments, the color scheme generation module 108b separately analyzes the pixels that are at the top and the bottom of the digital image (e.g., the areas surrounding the object). For example, the color scheme generation module 108b can generate one or more edge clusters for the pixels at the top and bottom, and then compare these edge clusters to the color clusters for the image that were generated as described above. If the RGB values of an edge cluster are within a predetermined distance of the RGB values of one or more of the general color clusters of the image, and if the RGB values of the edge cluster are within a range that represents human skin tone (e.g., meaning a person is holding the object in the image), the color scheme generation module 108b can delete the color cluster from the previously-generated color clusters—enabling the system to provide more accurate color clustering for the object in the image and preventing objects from being incorrectly assigned color clusters that relate to skin tone and not the object itself.

Next, the color scheme generation module 108b assigns (208) each of the plurality of pixels in the digital image to one or more of a plurality of color bins based upon the color values associated with the pixel. For example, the color scheme generation module 108b can generate a large number (e.g., thousands) of different color bins that are defined according to the RGB values. The module 108b compares the RGB values of each pixel and selects a plurality of color bins that are within a predetermined RGB value range of the RGB values of the pixel. The module 108b then assigns the pixel to each of these selected color bins to generate percentage values of pixels in the digital image that are assigned to each color bin.

Once the pixels have been assigned to the color bins, the color scheme generation module 108b defines (210) a color scheme data structure for the digital image based upon one or more characteristics of the assignment of the pixels to the plurality of color bins. For example, the bins can be aggregated and categorized according to their RGB values such that many bins together would comprise the color characteristic of red, or blue, or pastel, or rainbow, or any number of differently-defined color characteristics. As a result, if an image has over 50% of its pixels assigned to color bins that are categorized as red, the color scheme generation module 108b can define a color scheme data structure for the digital image that comprises the red characteristic. In another example, if an image has over 50% of its pixels assigned to color bins categorized as rainbow colors and at least 5% of its pixels assigned to each of five traditional rainbow colors (e.g., Red, Orange, Yellow, Green, Blue, Indigo, Violet), the color scheme generation module 108b can define a color scheme data structure for the digital image that comprises the rainbow characteristic. In this way, the color scheme generation module 108b advantageously defines a data structure relating to the percentage values used to represent what color characteristics are present in the digital image. In another example, the color scheme data structure relies on the maximum value of at least one value being present. For instance, if a user wanted to view items that were themed to be similar to the American flag, the color scheme generation module 108b can look for images with items that have any amount of White, and then at least 25% Old Glory Red OR 25% Old Glory Blue AND less than 5% colors that are not close to Old Glory Red, Old Glory Blue, white, or grey.

Then, the color scheme generation module 108b tags (212) the digital image with the defined color scheme data structure and the first plurality of color clusters generated as described above. For example, the module 108b can store an association (e.g., table mapping, metadata) between the digital image and the defined color scheme data structure in database 110, for use in searching and matching colors with digital images as described in detail below.

After the system 100 has analyzed digital images and tagged the images with a color scheme data structure as described above, the system 100 can provide operations to enable advanced searching based upon the color scheme data structure. An exemplary embodiment of the searching techniques described herein is in the context of product/color matching (e.g., for e-commerce or other types of web functionality).

For example, an e-commerce website may provide search functionality that includes a color filter which enables users to specify certain color values—the website then returns products that match the specified color values. It should be appreciated that other types of color matching and search functionality can be contemplated within the scope of invention.

Continuing with this example, a user at mobile device 102 may enter one or more color values (e.g., selecting from a color palette, hovering over an image and selecting a region of the image) into a user interface provided by application 103. The application 103 can convert the selected color into RGB values and use the converted RGB values as input to the search function of the application 103. Based upon the RGB values of the selected color, the application 103 can match these RGB values to the color scheme data structure that an image of the desired product is tagged with, including the color clusters assigned to the product image. In this way, the application 103 can quickly and dynamically produce tailored search results that include products with colors that accurately match the RGB values entered by the user.

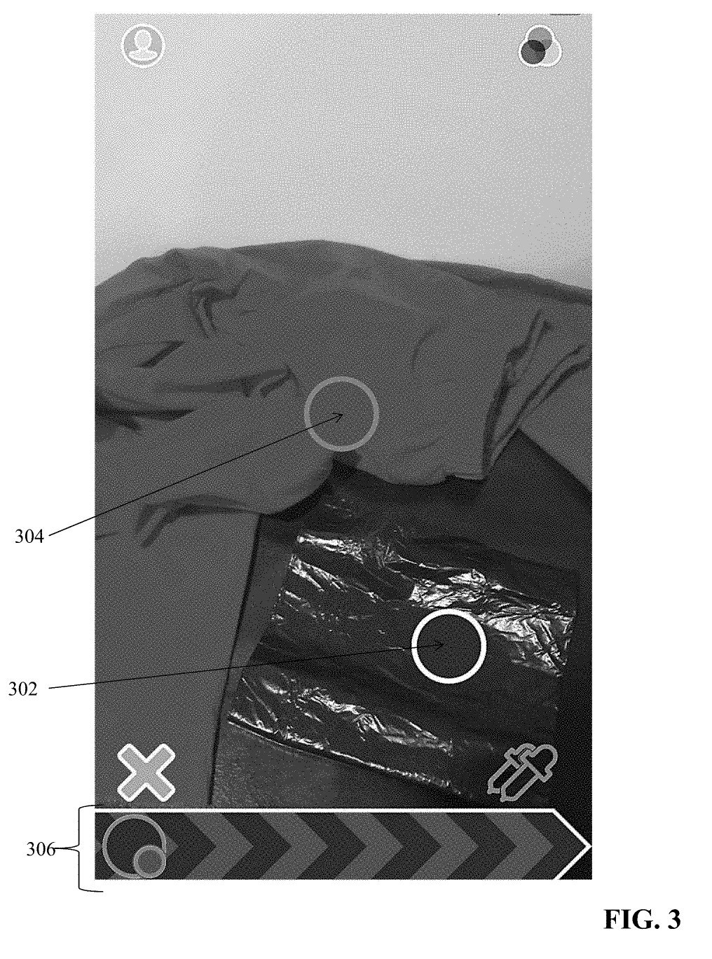

FIG. 3 is a screenshot of an application for dynamically generating color scheme data structures for digital images. As shown in FIG. 3, application 103 includes a digital image (e.g., captured by the user of the mobile device 102) in which the user has selected two different color areas in the image. In this case, selection 302 is a black fabric while selection 304 is a red jacket. The image analysis module 108a of the application 103 captures the color values associated with each of the selected areas 302, 304 as described above, and the color scheme generation module 108b converts the captured color values into a color scheme data structure—and represents the selected color scheme in the palette area 306 at the bottom of the screen, where the same selected colors are represented.

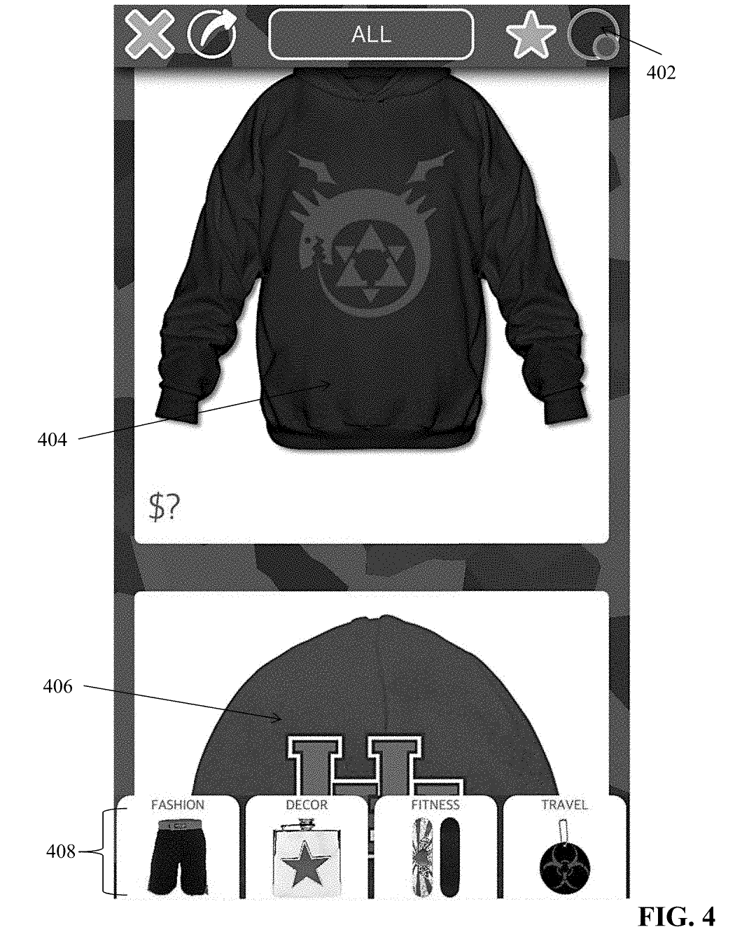

Once the user has selected colors and the color scheme generation module 108b has created a color scheme data structure, the application 103 can use the color scheme to search for images depicting items that have a common color with one or more of the colors in the color scheme data structure, using the techniques described above. FIG. 4 is a screenshot of the application presenting image search results of items (e.g., apparel) that contain the same color palette as identified in the color scheme data structure. As shown in FIG. 4, the red and black color palette appears in the upper right corner 402 of the screen, while one or more images of items (i.e., sweatshirt 404, cap 406) are displayed below. The main color of the sweatshirt 404 is black (very similar/same as the black in the color scheme) while the accent color of the sweatshirt 404 is red (again, very similar/same as the red in the color scheme). The user of the application 103 can select different item categories using the buttons 408 at the bottom of the screen to view other items that share the color palette.

It should be appreciated that generally, a user would want the application 103 to return products that are considered the “closest match.” However, this can be challenging when considering that color closeness does not easily map from mathematical values to human perception. To overcome this challenge, the system uses color matching with RGB values and Euclidian distance to colors. For example, if a user had selected a pixel from a digital image that had values of RGB(200,199,50), the application 103 should find product images that have color clusters of RGB(201,195,52)—due to the similarity between the RGB values. However, it is difficult to sort this type of result accurately. The application 103 can weigh the green dimension more heavily because (as is known) the human brain is more perceptive to changes in green versus blue, for example. In addition, the application 103 can perform a coordinate search in HSV because HSV is less sensitive to changes in darkness and saturation, and more sensitive to changes in hue. This is useful because although some colors (e.g., purple and magenta) are similar with respect to their RGB values, the colors are very different in terms of how a human describes them. In some instances, the application 103 can include a switch to be toggled such that there are thresholds on the perception. For instance, if a user searches for a color which is RGB (40,35,35), the application 103 can limit the results to not show any results which does not have more R than G or B. So, images with RGB (35,35,40) are never shown even if they traditionally appeared next. While these thresholds are not needed at every value, for some high impact areas this is important—as, e.g., a dark brown is dissimilar in appearance to a slate grey.

While the example workflow shown in FIGS. 3 and 4 relates to a double color search, it should be appreciated that the methods and systems described herein can be applied to a wide variety of different search techniques and color inputs, as set forth in the figures described below.

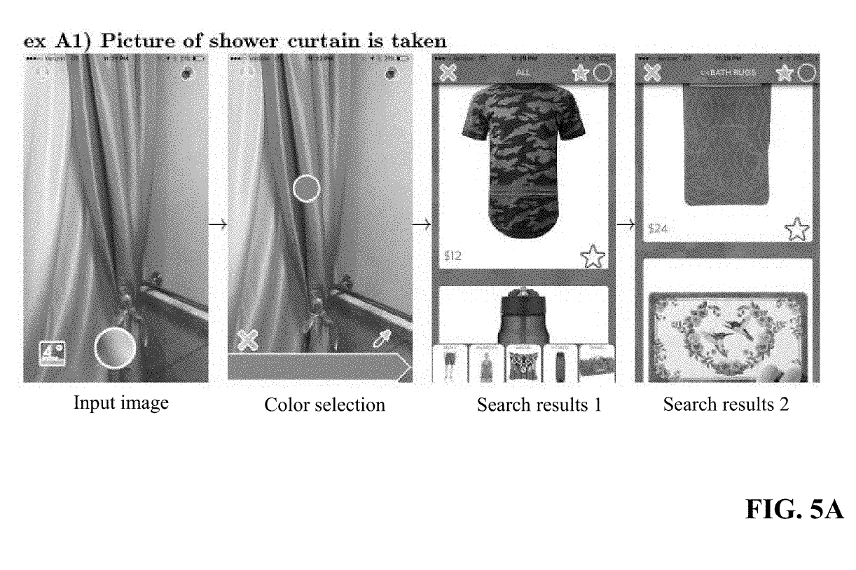

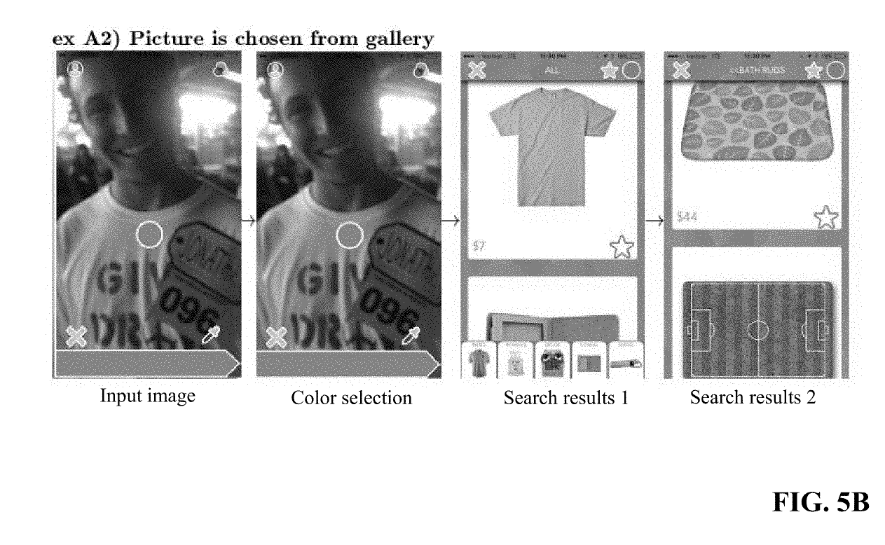

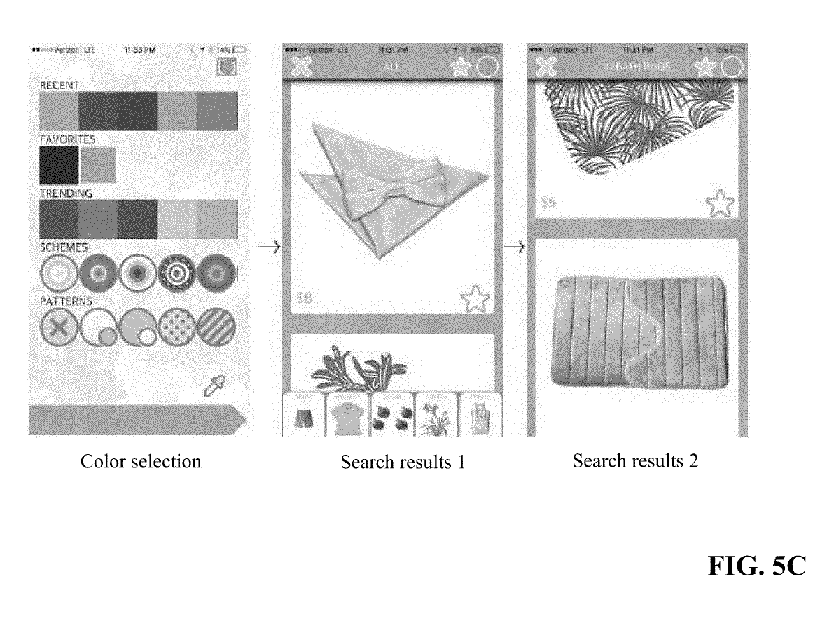

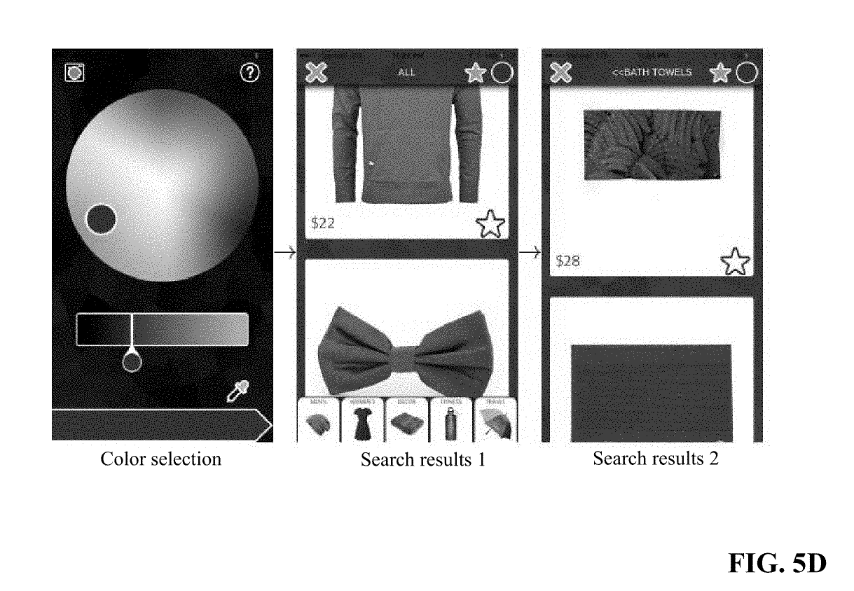

FIGS. 5A to 5D depict several groups of screenshots from the application 103 where different inputs are used to initiate the color search. While all of the colors used to search in FIGS. 5A to 5D may be considered “green” by a user, they all have unique visual appearances. In FIG. 5A, a user of application 103 on mobile device 102 takes a picture of a shower curtain (using the camera embedded in the mobile device 102) and selects a color of the curtain to use as the search input. As shown, the application 103 returns images of items (e.g., a shirt, a towel) that have main color(s) which match the selected color.

In FIG. 5B, a user of application 103 on mobile device 102 retrieves a picture of a person wearing a green t-shirt stored locally on the mobile device 102 (e.g., in a Photos or Gallery app) and selects a color of the t-shirt to use as the search input. As shown, the application 103 returns images of items (e.g., a shirt, a pillow) that have main color(s) which match the selected color.

In FIG. 5C, instead of using an image selected from an image as the input, a user of the application 103 selects a previously-used color and/or a suggested color (e.g., recent, favorite, trending)—or in some embodiments, a random color—from a selection screen as the color value input. As shown in FIG. 5C, the application 103 returns images of items (e.g., a bowtie, a mat) that have main color(s) which match the selected color.

In FIG. 5D, a user of the application 103 selects a custom color using a color selection user interface displayed by the application 103. As shown in FIG. 5D, the user interface includes a color circle with a large number of different colors that can be selected, and a color slider below that in which the user can fine-tune the specific shade of the selected color. Once a color is chosen, the application 103 returns images of items (e.g., a bowtie, a towel) that have main color(s) which match the selected color.

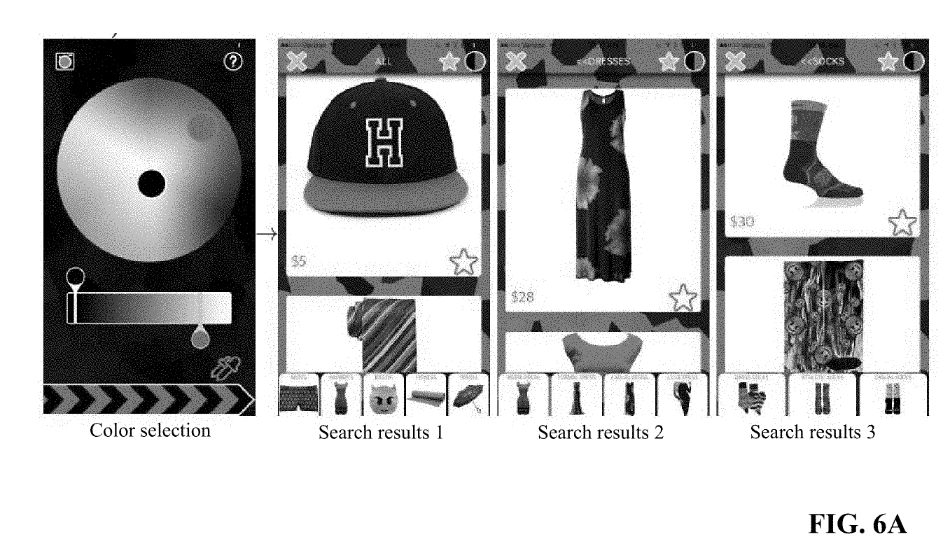

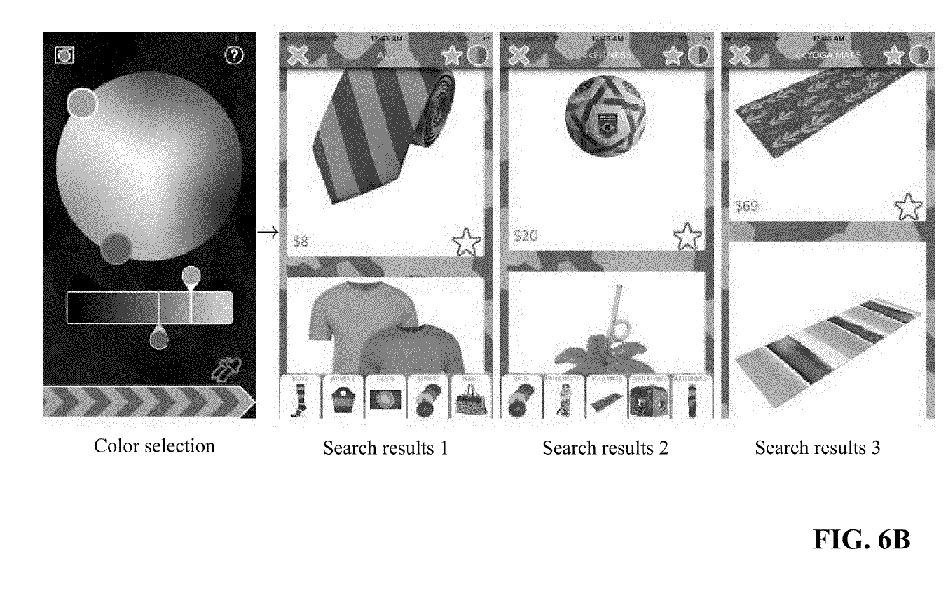

FIGS. 6A to 6B are additional examples of the double color workflow described above with respect to FIGS. 3 and 4. As shown in FIG. 6A, a user of application 103 selects a plurality of colors (e.g., black, purple) from the color selection circle in the user interface, and the application 103 returns images of items that have colors which match both of the selected colors. Similar results are shown in FIG. 6B (where the user selects green and yellow).

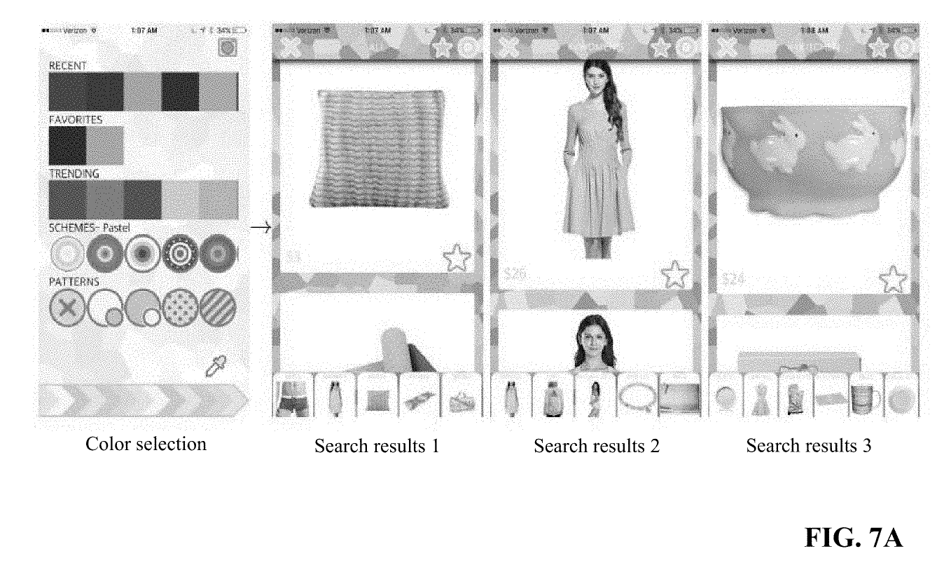

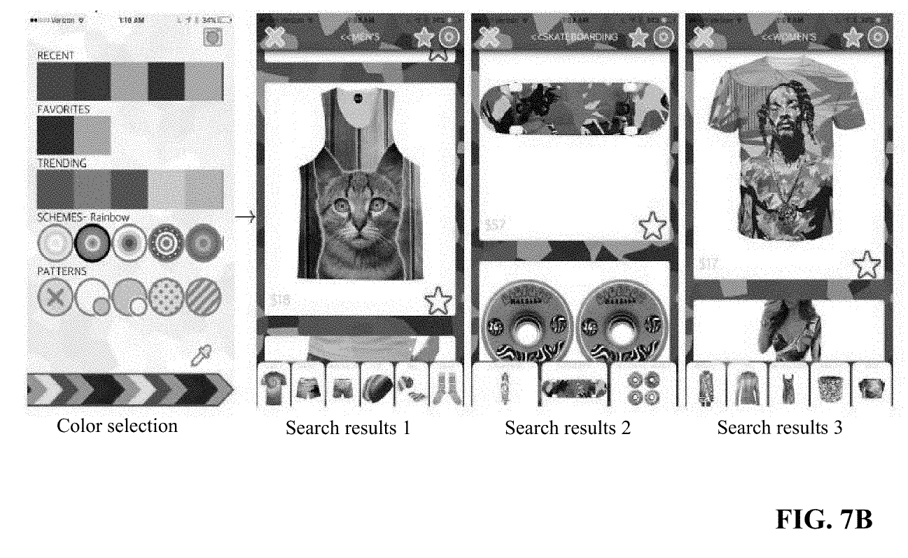

As mentioned previously, the application 103 can create color schemes that are complex but return interesting and intuitive search results. For instance, the application 103 can generate a ‘pastel’ color scheme which returns items with enough pixels within a pastel color range, or the application 103 can generate a ‘rainbow’ color scheme which returns items with enough pixels within the ROYGBIV colors typically associated with a rainbow. FIG. 7A is a screenshot depicting the pastel color scheme search, while FIG. 7B is a screenshot depicting the rainbow color scheme search. Other types of complex color schemes (e.g., grayscale, ‘American Flag (red,white,blue), ‘fire’, ‘earthtone’, etc.) can be contemplated within the scope of invention described herein.

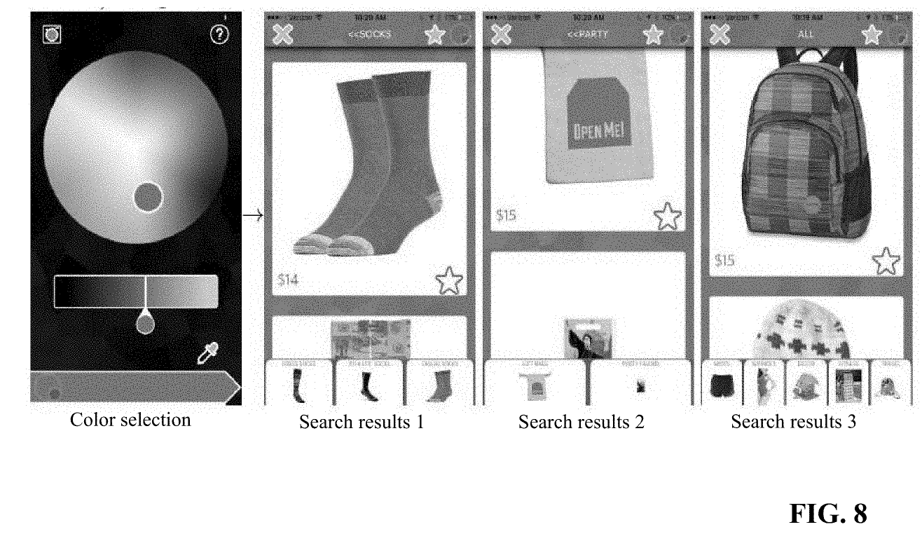

In addition, the application 103 can conduct more advanced color searching, such as accent color search (i.e., when the searched-for color is not the main color of the item) and/or pattern searching (i.e., dots, stripes, and the like). FIG. 8 is a screenshot of the application 103 where an input color is used as an accent search. As shown in FIG. 8, a user selects a color using the user interface input elements and selects the input color as an accent color. The application 103 (using the techniques described above) searches for images that have at least some pixels with the selected input color, but fewer than a predetermined percentage of pixels with that color. As a result, as shown in FIG. 8, the application 103 returns items where the selected color is not the main color of the item, but does appear. It should be appreciated that the application 103 can be configured to search for a plurality of accent colors, in addition to just one accent color.

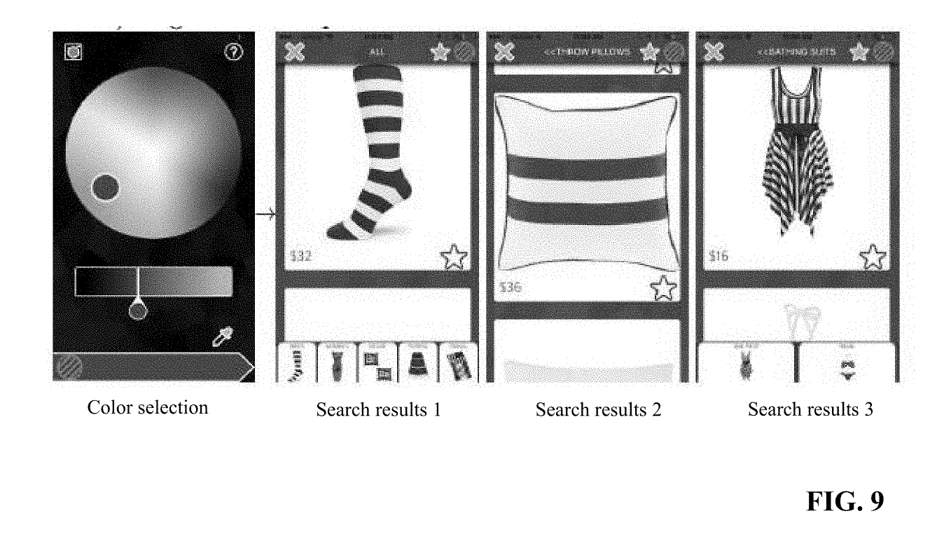

FIG. 9 is a screenshot of the application 103 where an input color is selected and a pattern matching selection is also used. As shown in FIG. 9, a user of the application 103 selects a color using the user interface input elements and also selects a ‘striped’ pattern in the area in the lower left of the leftmost screen. The application 103 executes a machine learning algorithm to identify patterns in the images, and returns images that have the selected color as part of a striped pattern on the item. As can be appreciated, other types of patterns can be searched and a plurality of colors can be selected for searching in a particular pattern (e.g., pink dots on a gray background).

Method steps can be performed by one or more special-purpose processors executing a computer program to perform functions of the invention by operating on input data and/or generating output data. Method steps can also be performed by, and an apparatus can be implemented as, special-purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special-purpose microprocessors. Generally, a processor receives instructions and data from a read-only memory or a random access memory or both. The essential elements of a computer are a specialized processor for executing instructions and one or more specifically-allocated memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device such as the Pixel™ from Google Inc. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A computerized method of generating a color scheme data structure for a digital image, the method comprising:
retrieving, by a computing device, a digital image of an object, the digital image comprising a plurality of pixels and each pixel comprising a plurality of color values;
generating, by the computing device, a first plurality of color clusters associated with the object based upon the color values of the plurality of pixels in the digital image, each color cluster in the first plurality of color clusters comprising a plurality of RGB values;
determining, by the computing device, a first count of pixels in the digital image that are similar to at least one of the color clusters and a second count of pixels in the digital image that are dissimilar to at least one of the color clusters;
assigning, by the computing device, each of the plurality of pixels in the digital image to one or more of a plurality of color bins based upon the color values associated with the pixel;
defining, by the computing device, a color scheme data structure for the digital image based upon one or more characteristics of the assignment of pixels to the plurality of color bins; and
tagging, by the computing device, the digital image with the defined color scheme data structure and the first plurality of color clusters.

2. The method of claim 1, further comprising:
determining, by the computing device, whether a portion of the plurality of pixels in the digital image are edge pixels; and
discarding, by the computing device, the digital image if a number of edge pixels in the digital image is below a predetermined threshold.

3. The method of claim 1, wherein generating a plurality of color clusters comprises:
mapping, by the computing device, each of the plurality of pixels in the digital image to a data point in a three-dimensional RGB space; and
clustering, by the computing device, the data points in the three-dimensional RGB space into a plurality of color clusters using the corresponding color values of the plurality of pixels in the digital image.

4. The method of claim 1, wherein determining a first count of pixels in the digital image that are similar to at least one of the color clusters comprises:
determining, by the computing device, a percentage of pixels in the digital image whose associated plurality of color values are within a predetermined distance of at least one of the color clusters.

5. The method of claim 1, wherein determining a second count of pixels in the digital image that are dissimilar to at least one of the color clusters comprises:
determining, by the computing device, a percentage of pixels in the digital image whose associated plurality of color values are not within a predetermined distance of one of the color clusters.

6. The method of claim 1, further comprising:
generating, by the computing device, a second plurality of color clusters based upon the color values of the plurality of pixels at the top of the digital image and at the bottom of the digital image;
comparing, by the computing device, the RGB values of the second plurality of color clusters to the RGB values of the first plurality of color clusters; and
discarding, by the computing device, color clusters from the first plurality of color clusters whose RGB values are within a predetermined distance from the RGB values of at least one of the second plurality of color clusters and whose RGB values are within a predetermined distance of RGB values associated with a human skin tone.

7. The method of claim 1, wherein each of the plurality of pixels in the digital image are assigned to one or more of a plurality of color bins based upon a range of the color values associated with the pixel.

8. The method of claim 1, wherein the one or more characteristics of the assignment of pixels to the plurality of color bins comprises a percentage of pixels assigned to at least a portion of the plurality of color bins.

9. The method of claim 8, wherein the defined color scheme for the digital image comprises a color tag based upon the percentage of pixels assigned to a particular set of color bins.

10. The method of claim 1, further comprising:
receiving, by the computing device, from a remote computing device, a search request comprising one or more product identifiers and one or more color identifiers;
determining, by the computing device, RGB values associated with the one or more color identifiers;
identifying, by the computing device, one or more digital images tagged with one or more color clusters that have RGB values within a predetermined distance of the RGB values associated with the one or more color identifiers; and
determining, by the computing device, one or more of the identified digital images that are associated with at least one of the one or more product identifiers.

11. A system for generating a color scheme data structure for a digital image, the system comprising:
means for retrieving a digital image of an object, the digital image comprising a plurality of pixels and each pixel comprising a plurality of color values;
means for generating a first plurality of color clusters associated with the object based upon the color values of the plurality of pixels in the digital image, each color cluster in the first plurality of color clusters comprising a plurality of RGB values;
means for determining a first count of pixels in the digital image that are similar to at least one of the color clusters;
means for determining a second count of pixels in the digital image that are dissimilar to at least one of the color clusters;
means for assigning each of the plurality of pixels in the digital image to one or more of a plurality of color bins based upon the color values associated with the pixel;
means for defining a color scheme data structure for the digital image based upon one or more characteristics of the assignment of pixels to the plurality of color bins; and
means for tagging the digital image with the defined color scheme data structure and the first plurality of color clusters.

12. The system of claim 11, further comprising:
means for determining whether a portion of the plurality of pixels in the digital image are edge pixels; and
means for discarding the digital image if a number of edge pixels in the digital image is below a predetermined threshold.

13. The system of claim 11, wherein the means for generating a plurality of color clusters comprises:
means for mapping each of the plurality of pixels in the digital image to a data point in a three-dimensional RGB space; and
means for clustering the data points in the three-dimensional RGB space into a plurality of color clusters using the corresponding color values of the plurality of pixels in the digital image.

14. The system of claim 11, wherein the means for determining a first count of pixels in the digital image that are similar to at least one of the color clusters comprises:
means for determining a percentage of pixels in the digital image whose associated plurality of color values are within a predetermined distance of at least one of the color clusters.

15. The system of claim 11, wherein the means for determining a second count of pixels in the digital image that are dissimilar to at least one of the color clusters comprises:
means for determining a percentage of pixels in the digital image whose associated plurality of color values are not within a predetermined distance of one of the color clusters.

16. The system of claim 11, further comprising:
means for generating a second plurality of color clusters based upon the color values of the plurality of pixels at the top of the digital image and at the bottom of the digital image;
means for comparing the RGB values of the second plurality of color clusters to the RGB values of the first plurality of color clusters; and
means for discarding color clusters from the first plurality of color clusters whose RGB values are within a predetermined distance from the RGB values of at least one of the second plurality of color clusters and whose RGB values are within a predetermined distance of RGB values associated with a human skin tone.

17. The system of claim 11, wherein each of the plurality of pixels in the digital image are assigned to one or more of a plurality of color bins based upon a range of the color values associated with the pixel.

18. The system of claim 11, wherein the one or more characteristics of the assignment of pixels to the plurality of color bins comprises a percentage of pixels assigned to at least a portion of the plurality of color bins.

19. The system of claim 18, wherein the defined color scheme for the digital image comprises a color tag based upon the percentage of pixels assigned to a particular set of color bins.

20. The system of claim 1, further comprising:
means for receiving, from a remote computing device, a search request comprising one or more product identifiers and one or more color identifiers;
means for determining RGB values associated with the one or more color identifiers;
means for identifying one or more digital images tagged with one or more color clusters that have RGB values within a predetermined distance of the RGB values associated with the one or more color identifiers; and
means for determining one or more of the identified digital images that are associated with at least one of the one or more product identifiers.
